(19) United States
(12) Patent Application Publication
(10) Pub. No.: US 2003/0176130 A1
(43) Pub. Date: Sep. 18, 2003

(54) Bonding machine for a substrate

(76) Inventor: Chi-Shih Lee, Taichung Hsien (TW)

Correspondence Address: Alan D. Kamrath, Rider, Bennett, Egan & Arundel. LLP, Suite 2000, 333 South Seventh Street, Minneapolis, MN, 55402, US

(21) Appl. No.: 10/322,837

(22) Filed: Dec. 18, 2002

(30) Foreign Application Priority Data
Mar. 18, 2002 (CN) 02205343.3

(51) Int. Cl. B32B 5/22; B32B 5/26; B32B 5/24; B32B 27/12

(52) U.S. Cl. 442/239; 442/268; 442/286; 442/381; 428/16

(57) ABSTRACT

A bonding machine includes a first feeding device for feeding a substrate, a glue-dispensing device for dispensing glue, a first pair of heating rolls for rolling and heating the substrate passing through it and transferring the glue to the substrate so as to form a glue layer on the substrate, a second feeding device for feeding a cover, and a second pair of heating rolls for bonding the cover with the substrate through the glue layer, thus forming a web. A cooling roll may be located downstream of the third heating roll and the fourth heating roll for cooling the substrate and the cover that have bonded together. A product-collecting reel may be located downstream of the third heating roll and the fourth heating roll for winding the resultant web.

### BACKGROUND OF INVENTION

1. Field of Invention

The present invention relates to a bonding machine for a substrate and more particularly to a bonding machine for bonding a layer of cloth, transparent film, or peelable paper to a substrate.

2. Related Prior Art

Plastic products are widely used in daily life, such as tablecloths, gloves, aprons, shower caps, shower curtains, raincoats, closets, etc. Among the plastic materials, polyvinyl chloride may react with heavy metal at high temperature and thus generate toxic gases and/or dioxin, which would injure human bodies and contaminate the environment. Applicant has developed plastic materials excluding polyvinyl chloride for making plastic products. Plastic material is generally processed to form a web and a layer of cloth, transparent film, or peelable paper is bonded to a side of the web. The present invention is intended to provide a bonding machine that is suitable for bonding a layer of cloth, transparent film, or peelable paper to a substrate made from a material including or excluding polyvinyl chloride.

### SUMMARY OF INVENTION

A bonding machine includes a first feeding device for feeding a substrate, a glue-dispensing device for dispensing glue, a first pair of heating rolls for rolling and heating the substrate passing through it and transferring the glue to the substrate so as to form a glue layer on the substrate, a second feeding device for feeding a cover, and a second pair of heating rolls for bonding the cover with the substrate through the glue layer, thus forming a web.

A cooling roll may be located downstream of the third heating roll and the fourth heating roll for cooling the substrate and the cover that have bonded together.

A product-collecting reel may be located downstream of the third heating roll and the fourth heating roll for winding the resultant web.

Other objects, advantages, and novel features of the invention will become more apparent from the following detailed description when taken in conjunction with the accompanying drawings.

### BRIEF DESCRIPTION OF DRAWINGS

FIG. 1 is a side view of a bonding machine in accordance with an embodiment of the present invention.

FIG. 2 is an enlarged view of a portion of the bonding machine shown in FIG. 1.

FIG. 3 is a partial side view of a cover processed by means of the machine shown in FIGS. 1 and 2.

FIG. 4 is a side view of a bonding machine in accordance with a second embodiment of the present invention.

FIG. 5 is an enlarged view of a portion of the bonding machine shown in FIG. 4.

FIG. 6 is a partial side view of a cover processed by means of the machine shown in FIGS. 4 and 5.

FIG. 7 is a perspective view of a web produced by means of the bonding machines shown in FIGS. 1˜6.

### DETAILED DESCRIPTION OF PREFERRED EMBODIMENT

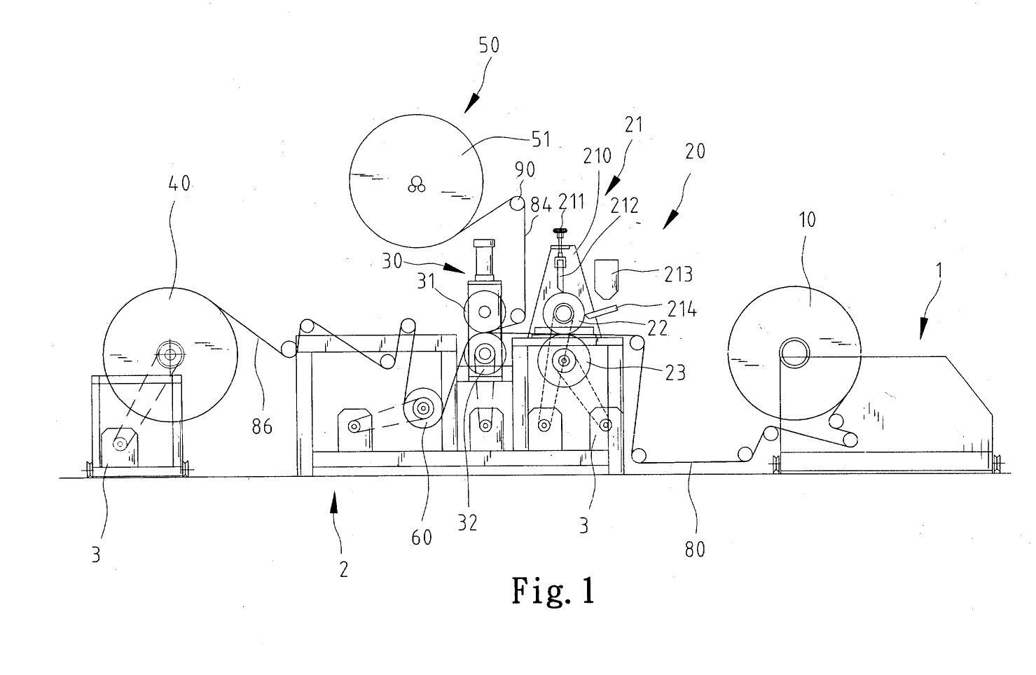

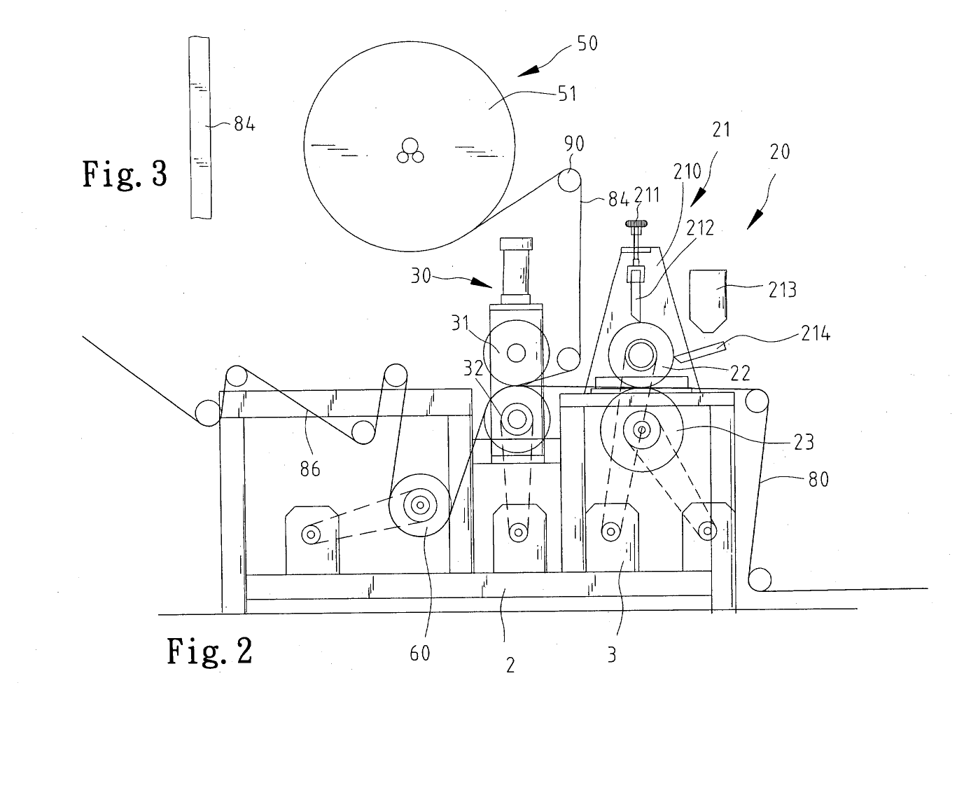

Referring to FIGS. 1 and 2, in accordance with an embodiment of the present invention, a bonding machine includes a first feeding device 1 including a reel 10 for feeding a substrate 80.

The bonding machine further includes a processing station 2 located downstream of the first feeding device 1. Mounted on a front end of the processing station 2 is a gluing mechanism 20.

The gluing mechanism 20 includes a rolling device, a glue-dispensing device and a roll-adjusting device.

The rolling device includes a first heating roll 22 and a second heating roll 23 located below the first heating roll 22. The first heating roll 22 is driven by means of a transmission mechanism 3. The second heating roll 23 is driven by means of another transmission mechanism 3. The transmission mechanisms 3 are conventional and therefore not described in detail. The heating rolls 22 and 23 form a nip for rolling the substrate 80. While rolling the substrate 80, the heating rolls 22 and 23 heat the substrate 80.

The glue-dispensing device includes a glue dispenser 213 and a feeder/scraper 214. The glue dispenser 213 is located in a properly high position so that glue can be fed from it because of gravity. The glue is dispensed to the first heating roll 22 through the feeder/scraper 214. The glue flows into a gap between the first heating roll 22 and the second heating roll 23. Then, the glue flows onto a side of the substrate 80 passing through the gap between the two rolls 22 and 23. Thus, a glue layer 82 is coated on the substrate 80.

The adjusting device 21 includes a frame 210, an adjusting bolt 211 mounted on the frame 210 and a scraper 212 attached to the adjusting bolt 211. The adjusting bolt 211 can be operated to adjust the gap between the scraper 212 and the first heating roll 22 in order to control the thickness of the glue layer 82 applied to the substrate 80. Namely, the scraper 212 scrapes redundant glue from the first heating roll 22.

Located downstream of the gluing mechanism 20 is a bonding device 30. The bonding device 30 includes a third heating roll 31 and a fourth heating roll 32 located below the third heating roll 31. The fourth heating roll 32 is driven by means of another transmission mechanism 3 to turn the third heating roll 31.

Near the bonding device 30 is located a second feeding device 50. The second feeding device 50 includes a reel 51 for feeding a cover 84. The cover 84 is a single layer of material as best shown in FIG. 3. The cover 84 is fed from the second feeding device 50 to the heating rolls 31 and 32 where it is bond with the substrate 80 through the glue layer 82. The cover 84 can be patterned by means of the third heating roll 31 when it is heated and rolled by means of the heating rolls 31 and 32. Two idle rolls 90 are provided to change the direction of the travel of the cover 84 coming from the second feeding device 50 and adjust the tension of the cover 84. Otherwise, the cover 84 would become slack as shown in phantom lines in FIG. 3.

A cooling roll 60 is located downstream of the gluing mechanism 20 and the bonding device 30. Low-temperature water is filled into the cooling roll 60 for cooling a resultant web 86 consisting of the substrate 80, the glue layer 82 and the cover 84 that are bonded. The cooling roll 60 is driven by means of another transmission mechanism 3.

Located downstream of the processing station 2 is a product-collecting reel 40 for winding the resultant web 86. The product-collecting reel 40 is driven by means of another transmission mechanism 3.

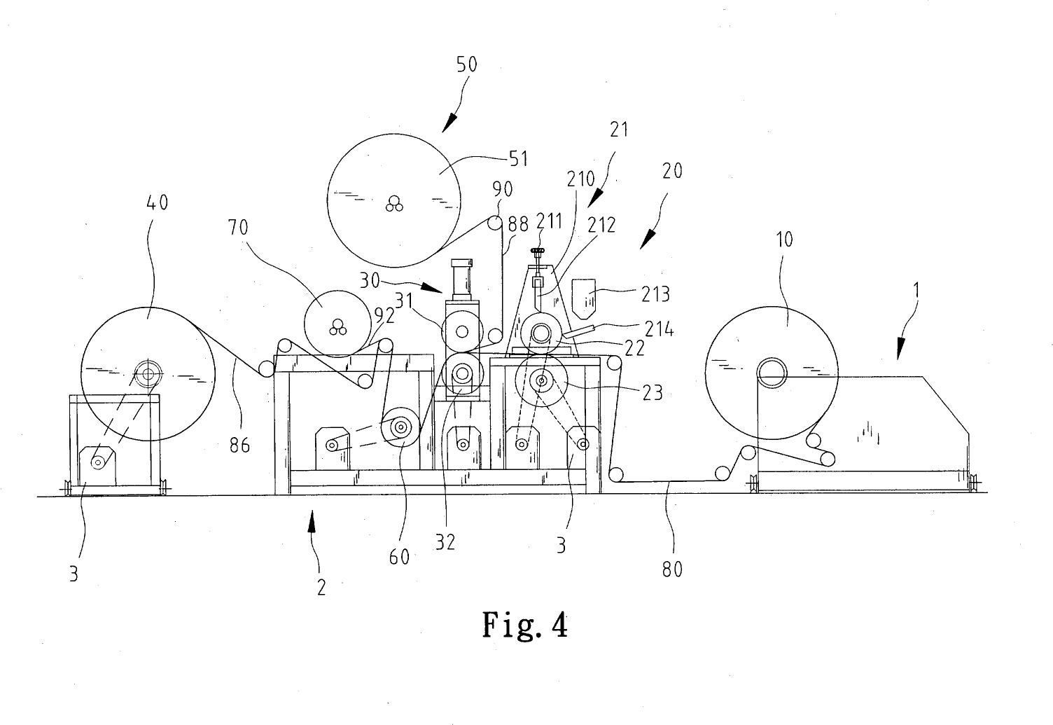

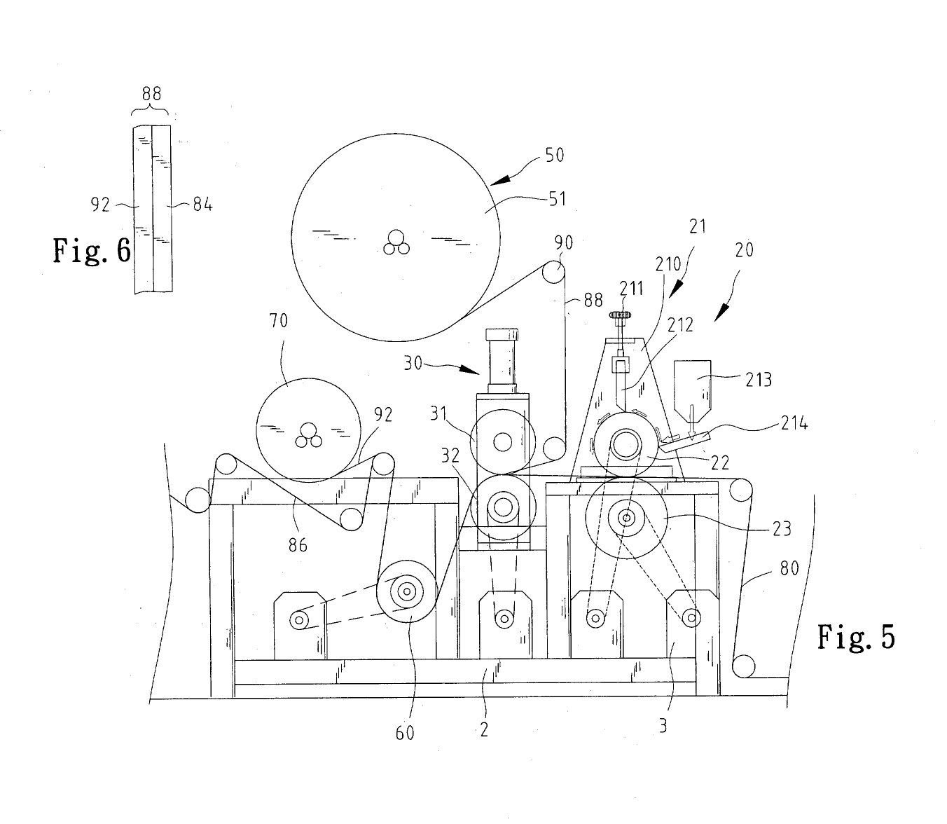

FIGS. 4 and 5 shows a bonding machine according to a second embodiment of the present invention. The second embodiment is structurally identical to the first embodiment except for providing a waste-collecting reel 70 located downstream of the cooling roll 60. The second embodiment is used to produce the web 86 from the substrate 80, the glue layer 82 and a cover assembly 88. As best shown in FIG. 6, the cover assembly 88 consists of the cover 84 and a protective film 92. The protective 92 is provided on the cover 84 for protective purposes and will later be removed from the cover 84. The cover assembly 88 is wound on the reel 51. From the reel 51, the cover assembly 88 is fed to the heating rolls 31 and 32 where it is rolled and heated. From the heating rolls 31 and 32, the substrate 80, the glue layer 82 and the cover assembly 88 are fed to the cooling roll 60 where they are cooled. From the cooling roll 60, the web 86 that consists of the substrate 80, the glue layer 82 and the cover 84 is fed to the product-collecting reel 40, while the protective film 92 is fed to the waste-collecting reel 70.

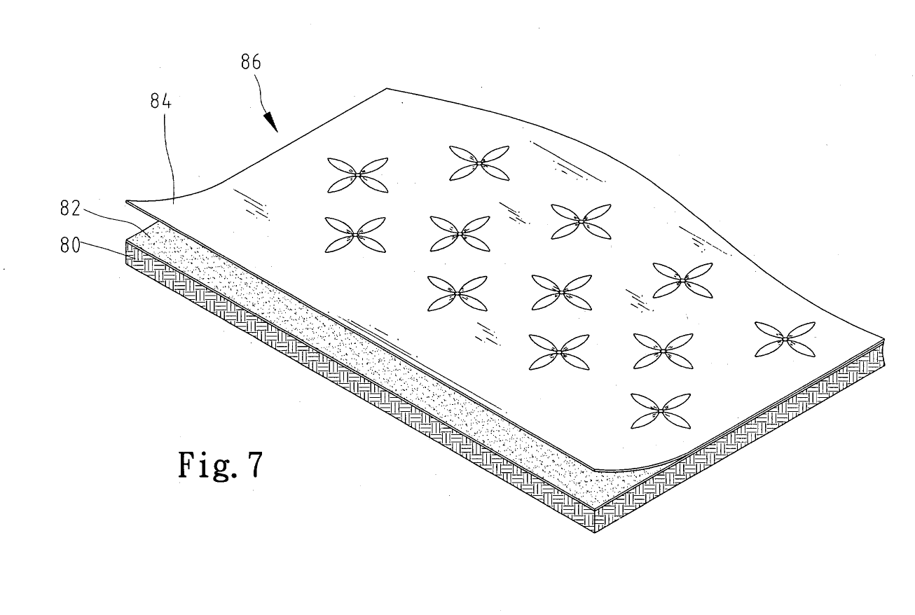

FIG. 7 shows the product 86 made by means of the above-described bonding machine according to the preferred embodiment of the present invention. The product 86 includes the substrate 80, the cover 84 and the glue layer 82 sandwiched between the substrate 80 and the cover 84. The substrate 80 may be made from plastics including or excluding polyvinyl chloride. The cover 84 may be a web of cloth or peelable paper or a transparent film

As described above, the bonding machines in accordance with the present invention provide a smooth operation for producing the web 86. Gluing and bonding are accomplished in the same machine.

The present invention has been described via illustration of some embodiments. The applicant gives these embodiments only as examples, and those skilled in the art can derive variations from the embodiments after a study of this specification. Therefore, these embodiments shall not limit the scope of the present invention that is defined in the following claims.

What is claimed is:

1. A bonding machine comprising:
a first feeding device for feeding a substrate;
a glue-dispensing device for dispensing glue;
a first pair of heating rolls for rolling and heating the substrate passing through it and transferring the glue to the substrate, thus forming a glue layer on the substrate;
a second feeding device for feeding a cover; and
a second pair of heating rolls for bonding the cover with the substrate through the glue layer, thus forming a web.

2. The bonding machine according to claim 1, comprising a cooling roll located downstream of the second pair of heating rolls for cooling the web.

3. The bonding machine according to claim 1, comprising a product-collecting reel for winding the web.

4. The bonding machine according to claim 1, wherein the first pair of heating rolls includes a first roll for transferring the glue and a second roll.

5. The bonding machine according to claim 4, comprising a scraper for scraping redundant glue from the first heating roll.

6. The bonding machine according to claim 5, comprising means for adjusting a gap between the scraper and the first heating roll.

7. The bonding machine according to claim 1, wherein the cover is a layer made of cloth.

8. The bonding machine according to claim 1, wherein the cover is a transparent film.

9. The bonding machine according to claim 1, wherein the cover is a layer of paper that can be peeled.

10. The bonding machine according to claim 1, wherein the cover is covered and protected by means of a protective film when it is fed from on the second feeding device.

11. The bonding machine according to claim 10, comprising a waste-collecting reel located downstream of the second pair of heating rolls for winding the protective film.

12. The bonding machine according to claim 1, wherein the substrate is made from polyvinyl chloride.

13. The bonding machine according to claim 1, wherein the substrate is made plastics excluding polyvinyl chloride.

14. A web including a substrate, a glue layer coated on the substrate and a cover coated on the glue layer, wherein the substrate, the glue layer and the cover are bonded via heating and rolling.

15. The web according to claim 14 wherein the substrate is a layer of a material selected from a group consisting of cloth and feather.

16. The web according to claim 14 wherein the cover is a layer of a material selected from a group consisting of cloth, paper and transparent film.

17. The web according to claim 14 wherein the cover is patterned when it is heated and rolled.
